(19) United States
(12) Patent Application Publication
(10) Pub. No.: US 2025/0137193 A1
(43) Pub. Date: May 1, 2025

(54) TABLET AND METHOD OF WASHING A FABRIC

(71) Applicant: PIKA DIAPERS ISRAEL LTD, Pardes Hannah (IL)

(72) Inventors: Alon COHEN, Pardes Hannah (IL); Moti DORFMAN, Ashdod (IL)

(21) Appl. No.: 18/836,026

(22) PCT Filed: Feb. 5, 2023
(86) PCT No.: PCT/IL2023/050127

§ 371 Date: Aug. 6, 2024

Related U.S. Application Data
(60) Provisional application No. 63/307,726, filed on Feb. 8, 2022.

(51) Int. Cl. D06L 1/16

(52) U.S. Cl. CPC D06L 1/16

(57) ABSTRACT

A method of washing a fabric is disclosed comprising the following consecutive steps: (i) performing at least two pre-washing cycles, wherein each pre-washing cycle comprises, washing said fabric with water at room temperature for 3 to 10 minutes, and draining the water for 2-10 minutes, thereby draining at least 30% of water volume; (ii) washing the fabric with a solution comprising water and detergent for 50 to 90 minutes at 35° C. to 90° C.; and (iii) performing at least three detergent-free post-washing cycles, wherein each post¬washing cycle comprises, washing said fabric soaked with water at room temperature for said 3 to 10 minutes and draining the water for said 2-10 minutes, thereby draining at least 30% of said water volume.

### FIELD OF THE INVENTION

This invention, in some embodiments thereof, relates to the field washing fabrics, and more particularly to a tablet and a method for washing a fabric.

### BACKGROUND

Laundry detergents in the form of tablets are widely used in many households these days. The first laundry tablets were introduced to the market in the mid-1960s. The first tablets failed to fully dissolve in water, accordingly new tablets with improved solubility were developed.

Laundry tablets contain a mixture of active and nonactive materials, such as, soluble solids, water softeners, surfactants, laundry bleaches, enzymes, perfumes, and pigments. Additional components may include, “antiredeposition agents” such as carboxymethyl cellulose which are used to prevent fine soil particles from reattaching to the product being cleaned, dye transfer inhibitors that prevent dyes from one article from coloring other items, (e.g., polar water-soluble polymers such as polyvinylpyrrolidone, to which the dyes preferentially bind) and the like.

Commercial washing machines use tablets or other forms of detergents during the first and sometimes second washing cycles. A washing cycle may be performed at temperatures raising from room temperature to 90° C. for 20 minutes to several hours. At the end of each washing cycle, the washing machine performs several (usually at least two) rinses to remove most of the detergent followed by optional spinning to extract the water.

One of the toughest fabrics to wash is a dirty fabric diaper, leading parents to prefer disposable diapers which cause a major environmental risk. An estimated 27.4 billion disposable diapers are used each year in the US, resulting in a possible 3.4 million tons of used diapers adding to landfills each year. A discarded disposable diaper takes approximately 450 years to decompose. Domestic washing machines fail to properly clean diapers, particularly of older toddlers.

Accordingly, there is a need for a new washing method for washing heavy dirt, such as feces, and a tablet that can efficiently remove the heavy dirt.

### SUMMARY

The following embodiments and aspects thereof are described and illustrated in conjunction with systems, tools, and methods which are meant to be exemplary and illustrative, not limiting in scope.

In one aspect, there is provided a method of washing a fabric, comprising the following consecutive steps:
(a) performing at least two pre-washing cycles, wherein each pre-washing cycle comprises, washing said fabric with water at room temperature for 3 to 10 minutes and draining the water for 2-10 minutes, thereby draining at least 30% of water volume;
(b) washing the fabric with a solution comprising water and detergent for 50 to 90 minutes at 35° C. to 90° C.; and
(c) performing at least three detergent-free post-washing cycles, wherein each post-washing cycle comprises, washing the fabric soaked with water at room temperature for 3 to 10 minutes and draining the water for 2-10 minutes, thereby draining at least 30% of said water volume.

In some embodiments, performing said at least two pre-washing cycles is with detergent-free water. In some embodiments, performing at least one pre-washing cycle from said at least two pre-washing cycles is with water containing a detergent. In some embodiments, step (a) comprises performing at least three pre-washing cycles. In some embodiments, said detergent comprises a tablet, comprising a first layer and a second layer, said first layer comprises by wt. %, at least 20 wt. % sodium carbonate; at least 10 wt. % a first nonionic surfactant; at least 10 wt. % a first anionic surfactant; at least 20 wt. % enzyme said enzyme is selected from the group consisting of protease, amylase, lipase, cellulase, mannanase, or any combination thereof; and said second layer comprises by wt. %, at least 30 wt. % sodium carbonate, at least 15 wt. % disinfectant, at least 5 wt. % second anionic surfactant and at least 5 wt. % second nonionic surfactant.

In some embodiments, the first anionic surfactant is the same as the second anionic surfactant. In some embodiments, the first nonionic surfactant is the same as the second nonionic surfactant. In some embodiments, said second layer is sandwiched between two first layers. In some embodiments, said first layer, said second layer, or both comprise at least 2 wt. % magnesium stearate. In some embodiments, said first layer, said second layer, or both comprise at least 2 wt. % microcrystalline cellulose. In some embodiments, said first layer, said second layer, or both comprise at least one water softener.

Some aspects of the invention are directed to a tablet, comprising a first layer and a second layer, said first layer comprises by wt. %, at least 20 wt. % sodium carbonate; at least 10 wt. % a first nonionic surfactant; at least 10 wt. % a first anionic surfactant; at least 20 wt. % enzyme, said enzyme is selected from the group consisting of: protease, amylase, lipase, cellulase, mannanase, or any combination thereof; and said second layer comprises by wt. %, at least 30 wt. % sodium carbonate, at least 15 wt. % disinfectant, at least 5 wt. % second anionic surfactant and at least 5 wt. % second nonionic surfactant.

In some embodiments, the first anionic surfactant is the same as the second anionic surfactant. In some embodiments, the first nonionic surfactant is the same as the second nonionic surfactant. In some embodiments, said second layer is sandwiched between two first layers. In some embodiments, said first layer, said second layer or both comprise at least 2 wt. % magnesium stearate. In some embodiments, said first layer, said second layer, or both comprise at least 2 wt. % microcrystalline cellulose.

In some embodiments, said first layer, said second layer, or both comprise a perfume. In some embodiments, said first layer, said second layer, or both comprise a pigment. In some embodiments, said enzyme is subtilisin.

In some embodiments, the disinfectant is sodium dichloroisocyanurate dihydrate. In some embodiments, said first layer, said second layer, or both comprise at least one water softener. In some embodiments, the first layer comprises by wt. %, at least 2 wt. % of a first water softener. In some embodiments, the first layer comprises by wt. %, at least 2 wt. % of a second water softener different from the first water softener. In some embodiments, said second layer comprises between 2-15 wt. % optical brightening agent.

In addition to the exemplary aspects and embodiments described above, further aspects and embodiments will become apparent by study of the following detailed description.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description together with the drawings makes apparent to those skilled in the art how embodiments of the invention may be practiced.

FIG. 1 is a flowchart of a method of washing a fabric according to some embodiments of the invention.

### DETAILED DESCRIPTION

The present invention is directed to a new washing method for washing heavy dirt, such as feces, and a tablet that can efficiently remove the heavy dirt. The new method includes additional pre-washing short cycles that help soften and remove the heavy dirt, a long washing cycle with a detergent that cleans the fabric, and at least three additional post-washing cycles that remove the detergent and the dirt.

In some embodiments, the detergent is a multilayered tablet that includes at least two layers, the first layer dissolves completely after at most 30 minutes and the second layer dissolves completely after at most 70 minutes at 40° C.

### The Washing Method

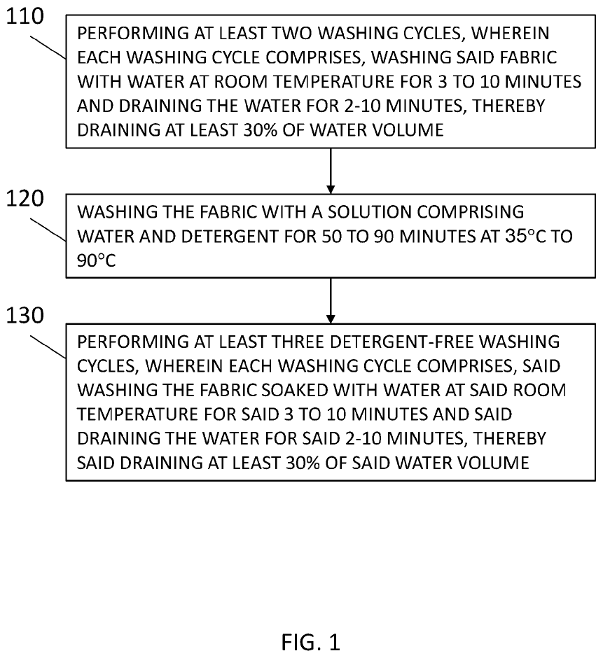

Reference is now made to FIG. 1 which is a flowchart of a method of washing a fabric according to some embodiments of the invention. The method of FIG. 1 may be performed by any commercial washing machine having a processor reprogramed to perform the method. Accordingly, the method may be executed by a washing machine processor. In step 110 at least two pre-washing cycles (e.g., 2, 3, 4, 5 cycles, etc.) are performed, wherein each washing cycle comprises, washing a fabric soaked with water for 3 to 10 minutes and draining the water for 2-10 minutes, thereby draining at least 30% (e.g., at least 40%, 50%, 60%, 70% or more) of water volume.

As used herein the term “fabric” may refer to any woven or nonwoven cloth, made from natural fibers, synthetic fibers, or a combination of both. For example, the fabric may be a reusable diaper. In some embodiments, the fabric may be dirty with heavy dirt, such as feces, mud, dry blood, etc.

In some embodiments, each pre-washing cycle may last 2 minutes, 3 minutes, 4 minutes, 5 minutes, 6 minutes, 7 minutes, 8 minutes, 9 minutes, 10 minutes, or more.

In some embodiments, the at least two pre-washing cycles in step 110 are performed with detergent-free water. In some embodiments, at least one washing cycle from said at least two pre-washing cycles in step 110 is performed with water containing a detergent. In some embodiments, the water is at room temperature. In some embodiments, at least one draining step may include spinning. In some embodiments, all the draining steps include spinning. Therefore, the draining drains at least 80% of water volume, for example, 85%, 90%, 93%, 95% or more.

In some embodiments, all pre-washing cycles are substantially identical having substantially the same duration and using substantially the same amount of water. Alternatively, the pre-washing cycles differ in at least one of, the washing duration, the amount of water, the use of detergent, the amount of drained water, and the addition of spinning. In some embodiments, each washing cycle may consume 2-30 liters of water. 5±2, 10±2, 15±2, 20±2, 25±2, 30±2, 35±2, 40±2, or more.

In step 120, the fabric may be washed with a solution comprising water and detergent for 50 to 90 minutes at 35° C. to 60° C. For example, the washing may be performed using a detergent tablet according to some embodiments of the invention, or with any other suitable detergent. In some embodiments, the washing may last 50 minutes, 60 minutes, 65 minutes, 70 minutes, 75 minutes, 80 minutes, 85 minutes, 90 minutes, or more.

In some embodiments, the washing solution may be heated to 35° C. In some embodiments, the washing solution may be heated to 40° C. In some embodiments, the washing solution may be heated to 45° C. In some embodiments, the washing solution may be heated to 50° C. In some embodiments, the washing solution may be heated to 55° C. In some embodiments, the washing solution may be heated to 60° C. In some embodiments, the washing solution may be heated to 70° C. In some embodiments, the washing solution may be heated to 80° C. In some embodiments, the washing solution may be heated to 90° C.

In some embodiments, a single type of detergent (a mono-detergent) may be used. In such case, a powder, a solution or a pod including more than one powder or solution may be added and dissolved at once.

In some embodiments, two different types of detergents each having different dissolving times may be added to the water. For example, the first detergent may include an enzyme (in addition to other active materials) and the second detergent may include a disinfectant (e.g., chlorinate in addition to other active materials). As would be clear to one skilled in the art when added together the disinfectant may destroy the enzyme. Accordingly, for both the enzyme and the disinfectant to work properly and disintegrate the dirt, the detergent comprising the enzyme must be completely dissolved when only a portion (e.g., less than 40 wt. %) of the detergent comprising the disinfectant is dissolved limiting the amount of disinfectant that may affect the enzyme. Therefore, the first detergent may dissolve in less than 30 minutes and the second detergent may dissolve in less than 90 minutes.

As used herein disinfectant may include any substance or compound used to inactivate or destroy microorganisms on nonliving objects. A disinfectant according to embodiments of the invention is configured to inactivate or destroy microorganisms, such as, bacteria, fungi, and viruses on fabrics.

In some embodiments, the first detergent comprises by wt. %, at least 20 wt. % sodium carbonate; at least 10 wt. % a first nonionic surfactant; at least 10 wt. % a first anionic surfactant; at least 20 wt. % enzyme said enzyme is selected from the group consisting of protease, amylase, lipase, cellulase, mannanase, or any combination thereof. In some embodiments, the second detergent comprises by wt. %, at least 30 wt. % sodium carbonate, at least 15 wt. % disinfectant, at least 5 wt. % second anionic surfactant, and at least 5 wt. % second nonionic surfactant.

In step 130, at least three detergent-free post-washing cycles may be performed, wherein each detergent-free post-washing cycle comprises, washing the fabric soaked with water at room temperature for 3 to 10 minutes and draining the water for 2-10 minutes, thereby draining at least 30% (e.g., at least 40%, 50%, 60%, 70% or more) of said water volume.

In some embodiments, at least one draining step may include spinning. In some embodiments, all the draining steps include spinning. Therefore, the draining drains at least 80% of water volume, for example, 85%, 90%, 92%, 95%, or more.

### The Tablet

A tablet according to embodiments of the invention may include a first layer and a second layer. In some embodiments, the first layer may include an enzyme, and the second layer may include a disinfectant. As would be clear to one skilled in the art, including both an enzyme and a disinfectant (e.g., chlorinate) in a mono-detergent may result in the destruction of the enzyme by the disinfectant. Accordingly, each one of the layers of the tablet according to embodiments of the invention may have a different dissolving time. In some embodiments, the first layer containing the enzyme may be dissolved in less than 30 minutes and the second layer containing the disinfectant may be dissolved in less than 90 minutes. Therefore, the layer comprising the enzyme will be completely dissolved when only a portion (e.g., less than 40 wt. %) of the layer comprising the disinfectant is dissolved. Limiting the amount of disinfectant that may affect the enzyme.

In some embodiments, the tablet may include more than two layers, such that said second layer is sandwiched between two first layers. In a nonlimiting example, the size of the tablet may be 40×40×17 mm. In some embodiments, the weight ratio between the first layer to the second layer is between 2 to 0.3. For example, the weight ratio between the first layer to the second layer is 1.7, 1.6, 1.5, 1.2, 1.1, 1, 0.9, 0.8, 0.7, 0.6 and 0.5.

In some embodiments, the total weight of the tablet may be between 20 to 40 gr. For example, the total weight of the tablet may be 24 gr., 26 gr., 28 gr., 30 gr., 32 gr., 35 gr., and 38 gr. In some embodiments, the total weight of the tablet may be more than 40 gr.

In some embodiments, the first layer is configured to completely dissolve in water after at most 30 minutes, for example, 25 minutes, 20 minutes, 15 minutes, or less. In some embodiments, the second layer is configured to completely dissolve in water after at most 70 minutes, for example, at most 65 minutes, 60 minutes, 50 minutes, 45 minutes, 40 minutes or less.

In some embodiments, the first layer comprises by wt. %, at least 20 wt. % sodium carbonate; at least 10 wt. % a first nonionic surfactant; at least 10 wt. % a first anionic surfactant; at least 20 wt. % enzyme said enzyme is selected from the group consisting of protease, amylase, lipase, cellulase, mannanase, or any combination thereof. In some embodiments, the second layer comprises by wt. %, at least 30 wt. % sodium carbonate, at least 15 wt. % disinfectant, at least 5 wt. % second anionic surfactant, and at least 5 wt. % second nonionic surfactant.

In some embodiments, the first anionic surfactant is the same as the second anionic surfactant. In some embodiments, the first nonionic surfactant is the same as the second nonionic surfactant.

In some embodiments, the first layer may include by wt. %, at least 5 wt. % a first anionic surfactant. In some embodiments, the first layer may include by wt. %, at least 7 wt. % a first anionic surfactant. In some embodiments, the first layer may include by wt. %, at least 8 wt. % a first anionic surfactant. In some embodiments, the first layer may include by wt. %, at least 10 wt. % a first anionic surfactant. In some embodiments, the first layer may include by wt. %, at least 12 wt. % a first anionic surfactant. In some embodiments, the first layer may include by wt. %, at least 13 wt. % a first anionic surfactant. In some embodiments, the first layer may include by wt. %, at least 14 wt. % a first anionic surfactant. In some embodiments, the first layer may include by wt. %, at least 15 wt. % a first anionic surfactant. In some embodiments, the first layer may include by wt. %, at least 17 wt. % a first anionic surfactant.

In some embodiments, the first layer may include by wt. %, at least 8 wt. % a first nonionic surfactant. In some embodiments, the first layer may include by wt. %, at least 10 wt. % a first nonionic surfactant. In some embodiments, the first layer may include by wt. %, at least 12 wt. % a first nonionic surfactant. In some embodiments, the first layer may include by wt. %, at least 15 wt. % a first nonionic surfactant. In some embodiments, the first layer may include by wt. %, at least 17 wt. % a first nonionic surfactant. In some embodiments, the first layer may include by wt. %, at least 20 wt. % a first nonionic surfactant. In some embodiments, the first layer may include by wt. %, at least 21 wt. % a first anionic surfactant. In some embodiments, the first layer may include by wt. %, at least 22 wt. % a first nonionic surfactant. In some embodiments, the first layer may include by wt. %, at least 25 wt. % a first nonionic surfactant.

In some embodiments, the second layer may include by wt. %, at least 5 wt. % a second anionic surfactant. In some embodiments, the second layer may include by wt. %, at least 7 wt. % a second anionic surfactant. In some embodiments, the second layer may include by wt. %, at least 8 wt. % a second anionic surfactant. In some embodiments, the second layer may include by wt. %, at least 10 wt. % a second anionic surfactant. In some embodiments, the second layer may include by wt. %, at least 12 wt. % second anionic surfactant. In some embodiments, the second layer may include by wt. %, at least 13 wt. % a second anionic surfactant. In some embodiments, the second layer may include by wt. %, at least 14 wt. % second anionic surfactant. In some embodiments, the second layer may include by wt. %, at least 15 wt. % a second anionic surfactant. In some embodiments, the second layer may include by wt. %, at least 17 wt. % a second anionic surfactant.

In some embodiments, the second layer may include by wt. %, at least 5 wt. % a first nonionic surfactant. In some embodiments, the second layer may include by wt. %, at least 10 wt. % a second nonionic surfactant. In some embodiments, the second layer may include by wt. %, at least 12 wt. % a second nonionic surfactant. In some embodiments, the second layer may include by wt. %, at least 15 wt. % a second nonionic surfactant. In some embodiments, the second layer may include by wt. %, at least 17 wt. % a second nonionic surfactant. In some embodiments, the first second may include by wt. %, at least 20 wt. % a second nonionic surfactant.

The term “anionic surfactant” refers to any surfactant containing an anionic functional group including sulfate, sulfonate, phosphate, and carboxylates.

In some embodiments, the anionic surfactant of the invention is or comprises alkyl benzene sulfonate, alcohol ether sulfate, secondary alkane sulfonates and alkyl sulfates including any combination and/or any salt thereof.

In some embodiments, the anionic surfactant of the invention is or comprises alkylbenzenesulfonate (e.g. linear (C5-C20) alkylbenzene sulfonates, such as sodium dodecylbenzenesulfonate), ammonium lauryl sulfate, sodium lauryl sulfate or (sodium dodecyl sulfate, SDS), sodium laureth sulfate (sodium lauryl ether sulfate or SLES), sodium myreth sulfate, dioctyl sodium sulfosuccinate (Docusate), perfluorooctanesulfonate (PFOS), perfluorobutanesulfonate, alkyl-aryl ether phosphates, alkyl ether phosphates, sodium stearate, sodium lauryl sarcosinate, perfluorononanoate, and perfluorooctanoate (PFOA or PFO), including any salt thereof. In some embodiments, the anionic surfactant is SDS.

The term “nonionic surfactant” refers to any surfactant having covalently linked oxygen-containing hydrophilic groups, which are bonded to hydrophobic parent structures.

In some embodiments, the surfactant of the invention is or comprises a non-ionic surfactant. In some embodiments, the nonionic surfactant of the invention is or comprises alkoxylated fatty acid, glucosyl dialkyl ether, polysorbate, span, tween, a polyether, a polyol, a polysaccharide, a polypeptide, a polyester, polyvinyl acetate, polyacrylamide, and polyacrylate, including any mixture or a copolymer thereof. Other non-ionic surfactants are well-known in the art. In some embodiments, the nonionic surfactant of the invention comprises a polymeric surfactant (e.g. a dispersant). Numerous dispersants are well-known in the art. In some embodiments, alkoxylated fatty acid comprises ethoxylated castor oil.

In some embodiments, the non-ionic surfactant of the invention comprises a polymeric surfactant comprising a polyether, a polyol (e.g. polyvinyl alcohol or PVA), a polysaccharide (e.g. cellulose, alkylated cellulose, or any other cellulose derivative), a polypeptide, a polyester, polyvinyl acetate, polyacrylamide, and polyacrylate, including any mixture or a copolymer thereof.

Non-limiting examples of nonionic surfactants include, but are not limited to, polysorbate (e.g., polysorbate 20, 40, 60, and 80), ethoxylated castor oil, narrow-range ethoxylate, octaethylene glycol monododecyl ether, pentaethylene glycol monododecyl ether, nonoxynols, triton X-100, polyethoxylated tallow amine, cocamide monoethanolamine, cocamide diethanolamine, poloxamers, glycerol monostearate, glycerol monolaurate, sorbitan monolaurate, sorbitan monostearate, sorbitan tristearate, decyl glucoside, lauryl glucoside, octyl glucoside, lauryldimethylamine oxide, dimethyl sulfoxide, phosphine oxide, and others. In some embodiments, the nonionic surfactant is polysorbate 20.

In some embodiments, the surfactant of the invention comprises a polyether. In some embodiments, the polyether comprises an aliphatic polyglycol, also used herein as polyalkoxylate. In some embodiments, the polyether comprises polyethylene glycol (PEG), alkylated PEG, polypropylene glycol (PPG), alkylated PPG, branched PEG, branched PPG, polytetramethylene ether glycol, amino-modified polypropylene glycol, and ester-modified polypropylene glycol, or any copolymer comprising PPG and PEG blocks. Other polyethers include inter alia modified C5-C18 fatty alcohol ethoxylates, C10-C18 oxo alcohol ethoxylates, C16-18 unsaturated fatty alcohol ethoxylates, Sorbitan ester ethoxylates, castor oil ethoxylates or any combination thereof. Exemplary polyalkoxylate based surfactants are well-known in the art and include inter alia Agnique® Disponil®, Emulan®, Eumulgin®, Lutensol®, Synperonic®.

In some embodiments, the surfactant of the invention comprises a polyol. In some embodiments, the polyol comprises a polyalkyl backbone comprising a plurality of hydroxy groups and optionally carboxy group and/or C1-C10 carboxylate group bound thereto. In some embodiments, the polyol or polyalcohol is at least partially derived from a polysaccharide (e.g. by de-esterification). In some embodiments, the polyol comprises at least partially de-esterified or hydrolyzed polysaccharide.

In some embodiments, the polyol comprises polyester polyols (e.g. dicarbonic acids such as adipic acid, sebacic acid, itaconic acid, maleic (acid) anhydride, terephthalic acid, isophthalic acid, fumaric acid, succinic acid, oxalic acid, malonic acid, glutaric acid, pimelic acid, suberic acid, and azelaic acid; polyester polyols selected from polyol compounds such as ethylene glycol, diethylene glycol, propylene glycol, 1,4-butanediol, 1,6-hexanediol, neopentyl glycol, 1,2-propanediol, 1,3-propanediol, 1,9-nonanediol, 3-methyl-1,5-pentanediol, tripropylene glycol, trimethylolpropane, and glycerol; as well as polylactone polyester polyols such as polycaprolactone polyols and (poly)β-methyl-α-valerolactone), polyolefin-based polyols (e.g. (poly)hydroxy polymer), polyolic xylene resins, polybutadiene-based polyols (e.g. polyols consisting of homopolymers having polybutadiene backbones (1,2 adducts and 1,4 adducts); polyols consisting of polybutadiene copolymers in which butadiene, and styrene and acrylonitrile are copolymerized; as well as hydrogenated analogues of these), polyether polyols, acrylic polyols, and castor-oil derivatives (e.g. refined castor oil, dehydrated castor oil, polymerized dehydrated castor oil, and castor-oil polyols).

In some embodiments, the surfactant of the invention comprises PVA (e.g. a water soluble PVA, a polymeric resin comprising PVA or any copolymer of PVA). In some embodiments, the surfactant of the invention comprises PVA, wherein the PVA is derived from polyacetate. In some embodiments, the surfactant of the invention comprises at least partially de-esterified or hydrolyzed polyacetate. In some embodiments, the PVA of the invention comprises between 70 and 90%, between 70 and 75%, between 75 and 80%, between 80 and 85%, between 85 and 90%, between 90 and 95%, between 95 and 99% by weight of the de-esterified or hydrolyzed polyvinylacetate. Exemplary PVA polymeric surfactants include but are not limited to Poval 4-88@, Poval 5-88@Poval 6-88@Poval 8-88@including any mixture thereof.

In some embodiments, the surfactant of the invention is or comprises a polymeric surfactant (e.g. PVA), wherein a weight average molecular weight of the polymeric surfactant is from 10,000 to 250,000, from 10,000 to 250,000, from 10,000 to 20,000, from 20,000 to 30,000, from 30,000 to 40,000, from 40,000 to 50,000, from 50,000 to 60,000, from 60,000 to 70,000, from 70,000 to 80,000, from 80,000 to 90,000, from 90,000 to 100,000, from 100,000 to 150,000, from 150,000 to 200,000, from 200,000 to 250,000, including any range or value therebetween.

In some embodiments, the surfactant of the invention is or comprises PVA derived from polyvinylacetate having a weight average molecular weight of the polymeric surfactant is from 10,000 to 250,000 including any range or value therebetween. In some embodiments, the surfactant of the invention is or comprises a plurality of PVA polymers, having different molecular weight and/or de-esterification degree (e.g. between 70 and 90% including any range therebetween).

In a nonlimiting example, the enzyme is subtilisin.

In a nonlimiting example, the disinfectant may include a salt-containing chlorine, such as, sodium dichloroisocyanurate dihydrate. Additional optional salts-containing chlorine may include sodium hypochlorite, trichloroisocyanuric acid,

In some embodiments, said first layer, said second layer, or both comprise at least 2 wt. % magnesium stearate from the total weight of each layer. For example, the second layer and/or the first layer may include 4 wt. % magnesium stearate, 5 wt. % magnesium stearate, 6 wt. % magnesium stearate, 7 wt. % magnesium stearate, 8 wt. % magnesium stearate or more.

In some embodiments, the first layer, the second layer, or both comprise at least 2 wt. % microcrystalline cellulose from the total weight of each layer. For example, the first layer may include 5 wt. % microcrystalline cellulose 8 wt. % microcrystalline cellulose, 10 wt. % microcrystalline cellulose, 15 wt. % microcrystalline cellulose, 20 wt. % microcrystalline cellulose, 22 wt. % microcrystalline cellulose, 25 wt. % microcrystalline cellulose, 28 wt. % microcrystalline cellulose, 30 wt. % microcrystalline cellulose and 32 wt. % microcrystalline cellulose.

In some embodiments, the first layer, the second layer, or both comprise a perfume. In some embodiments, said first layer, said second layer or both comprise a pigment.

In some embodiments, the second layer comprises between 2-15 wt. % ethylenediaminetetraacetic acid.

In some embodiments, said first layer, said second layer or both comprise at least one water softener. In some embodiments, the first layer comprises by wt. %, at least 2 wt. % of a first water softener, for example, 2.2 wt. %, 2.4 wt. %, 2.5 wt. %, 2.7 wt. % 3 wt. %, 3.2 wt. %, 3.4 wt. %, 3.5 wt. %, 4 wt. % or more. In some embodiments, wherein the first layer further comprises by wt. %, at least 2.5 wt. % of a second water softener, different from the first, for example, 2.5 wt. %, 2.7 wt. % 3 wt. %, 3.2 wt. %, 3.4 wt. %, 3.5 wt. %, 4 wt. % or more. In a nonlimiting example, the first water softener is polyphosphonic acid sodium salt. In another nonlimiting example, the second water softener is polyacrylic acid, sodium salt. Other possible water softeners may be selected from, sodium tripolyphosphate, potassium diphosphate, diethylester dimethyl ammonium chloride and the like.

In some embodiments, said first layer, said second layer, or both comprise at least one antiredeposition agents such as carboxymethyl cellulose. For example, each layer may include by wt. % at least 2 wt. % carboxymethyl cellulose, for example, 2.3 wt. %, 2.4 wt. %, 2.5 wt. %, 2.6 wt. %, 2.7 wt. %, 2.8 wt. %, 2.9 wt. % 3 wt. % or more.

In some embodiments, the second layer comprises between 0.1-0.5 wt. % optical brightening agent. For example, the optical brightening agent may be benzenesulfonic acid, 2,2′-([1,1′-biphenyl]-4,4′-diyldi-2,1-ethenediyl)bis-, disodium salt.

In some embodiments, the tablet may be fabricated using any known method. For example, the elements of the first layer may be mixed together (to form a first mixture and the elements of the second layer may be mixed together to form a second mixture. The first mixture may be poured and compacted in a mold and the second mixture may be poured on top of the first mixture and compacted in the mold. The tablet may be dried to add additional strength.

Various embodiments and aspects of the present invention as delineated hereinabove and as claimed in the claims section below find experimental support in the following examples.

### Examples

Table 1 includes the composition of a tablet according to some embodiments of the invention. The tablet includes two layers, a first layer weighing 16 gr. and a second layer weighing 12 gr.

TABLE 1
26 gr. tablet

| | | | |
|---|---|---|---|
| | % each | Weight | |
| Element | layer | gr. | Chemical name |

1st layer 16 gr.

| | | | |
|---|---|---|---|
| Microcrystalline cellulose | 25.00% | 4 | Microcrystalline cellulose |
| PerfumeIBG 2152 GNF LPV | 4.60% | 0.736 | |
| MOD | | | |
| Sodium carbonate | 25.30% | 4.048 | sodium carbonate |
| Carboxymethyl Cellulose | 2.80% | 0.448 | Sodium carboxymethyl cellulose |
| Phosphonate | 2.50% | 0.4 | Polyphosphonic acid sodium salt |
| Polyacylic acid | 3.50% | 0.56 | polyacrylic acid, sodium salt |
| Alcohol C16-18 ethoxylated | 8.60% | 1.376 | C16C18-Fatty alcohol + 80 EO |
| Sodium Lauryl Sulfate | 17.30% | 2.768 | Dodecyl Sodium Sulfate |
| Enzymes Medley Brilliant 105 T | 10.40% | 1.664 | Protease (Subtilisin) |
| | 100.00% | 16.00 | |

2nd layer 12 gr.

| | | | |
|---|---|---|---|
| Sodium carbonate | 33.08% | 3.9696 | sodium carbonate |
| Sodium metasilicate | 8.00% | 0.96 | Disodium metasilicate pentahydrate |
| Alcohol C16-18 ethoxylated | 9.30% | 1.116 | C16C18-Fatty alcohol + 80 EO |
| Sodium Lauryl Sulfate | 12.80% | 1.536 | Dodecyl Sodium Sulfate |
| Optical brightening agent | 0.12% | 0.0144 | Benzenesulfonic acid, 2,2′-([1,1′- |
| | | | biphenyl]-4,4′-diyldi-2,1- |
| | | | ethenediyl)bis-, disodium salt |
| Sodium dichloroisocyanurate | 23.40% | 2.808 | Sodium dichloroisocyanurate, |
| | | | dihydrate |
| Carboxymethyl Cellulose | 2.30% | 0.276 | Sodium carboxymethyl cellulose |
| EDTA | 5.00% | 0.6 | tetrasodium ethylene diamine |
| | | | tetraacetate |
| Magnesium stearate | 6.00% | 0.72 | Octadecanoic acid, magnesium salt |
| | 100.00% | 12.00 | |

Table 2 includes the composition of another tablet according to some embodiments of the invention. The tablet includes three layers, two external first layers weighing 7 gr. each and a second middle layer weighing 14 gr.

| | | | |
|---|---|---|---|
| | % each | Weight | |
| Element | layer | gr. | Chemical name |

1st layers 7 gr.

| | | | |
|---|---|---|---|
| Sodium metasilicate | 8% | 0.28 | Sodium metasilicate |
| PerfumeIBG 2152 GNF LPV | 5% | 0.35 | |
| MOD | | | |
| Pigment | 1% | 0.07 | |
| Sodium carbonate | 27% | 1.89 | sodium carbonate |
| Carboxymethyl Cellulose | 2% | 0.14 | Sodium carboxymethyl cellulose |
| Phosphonate | 3% | 0.21 | Polyphosphonic acid sodium salt |
| Polyacylic acid | 4% | 0.28 | polyacrylic acid, sodium salt |
| Alcohol C16-18 ethoxylated | 5% | 0.35 | C16C18-Fatty alcohol + 80 EO |
| Sodium Lauryl Sulfate | 10% | 0.7 | Dodecyl Sodium Sulfate |
| Enzymes Medley Brilliant 105 T | 35% | 2.45 | Protease (Subtilisin) |
| | 100.00% | 7.00 | |

2nd layer 14 gr.

| | | | |
|---|---|---|---|
| Sodium carbonate | 39% | 5.46 | sodium carbonate |
| Sodium metasilicate | 8% | 1.12 | Disodium metasilicate pentahydrate |
| Alcohol C16-18 ethoxylated | 5% | 0.7 | C16C18-Fatty alcohol + 80 EO |
| Sodium Lauryl Sulfate | 7% | 0.98 | Dodecyl Sodium Sulfate |
| Optical brightening agent | 0.1% | 0.014 | Benzenesulfonic acid, 2,2′-([1,1′- |
| | | | biphenyl]-4,4′-diyldi-2,1- |
| | | | ethenediyl)bis-, disodium salt |
| PerfumeIBG 2152 GNF LPV | 0.9 | 0.126 | |
| MOD | | | |
| Polyacylic acid | 4% | 0.56 | polyacrylic acid, sodium salt |
| Sodium dichloroisocyanurate | 20% | 2.8 | Sodium dichloroisocyanurate, |
| | | | dihydrate |
| Carboxymethyl Cellulose | 3% | 0.42 | Sodium carboxymethyl cellulose |
| EDTA | 10% | 1.4 | tetrasodium ethylene diamine |
| | | | tetraacetate |
| Magnesium stearate | 3. % | 0.42 | Octadecanoic acid, magnesium salt |
| | 100.00% | 14.00 | |

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

1. A method of washing a fabric, comprising the following consecutive steps:
performing at least two pre-washing cycles, wherein each pre-washing cycle comprises, washing said fabric with water at room temperature for 3 to 10 minutes and draining the water for 2-10 minutes, thereby draining at least 30% of water volume;
washing the fabric with a solution comprising water and detergent for 50 to 90 minutes at 35° C. to 90° C.; and
performing at least three detergent-free post-washing cycles, wherein each post-washing cycle comprises, washing the fabric soaked with water at room temperature for 3 to 10 minutes and draining the water for 2-10 minutes, thereby draining at least 30% of said water volume,
wherein performing said at least two pre-washing cycles is with detergent-free water.

2-3. (canceled)

4. The method according to claim 1, wherein said performing said at least two pre-washing cycles comprises performing at least three pre-washing cycles.

5-25. (canceled)

26. The method according to claim 1, wherein the water is at room temperature.

27. The method according to claim 1, wherein the draining drains at least 80% of water volume, for example, 85%, 90%, 93%, 95% or more. 5.

28. The method according to claim 1, wherein at least one draining step includes spinning.

29. The method according to claim 1, wherein all the draining steps include spinning.

30. The method according to claim 1, wherein all pre-washing cycles are substantially identical having substantially the same duration and using substantially the same amount of water
